(19) United States
(12) Patent Application Publication
(10) Pub. No.: US 2020/0119686 A1
(43) Pub. Date: Apr. 16, 2020

(54) Method and Apparatus for Reflecting Solar Energy to Bifacial Photovoltaic Modules

(71) Applicant: William Leonard Driscoll, Arlington, VA (US)

(72) Inventor: William Leonard Driscoll, Arlington, VA (US)

(21) Appl. No.: 16/156,296

(22) Filed: Oct. 10, 2018

(51) Int. Cl. H02S 40/22

(52) U.S. Cl. CPC H02S 40/22

(57) ABSTRACT

A method and apparatus for using a solar energy reflecting article, encompassing at least one ordered arrangement of reflector elements, each of which elements has a relatively flat, highly reflective face at an angle of primary reflection, with said article designed for a particular solar installation, such that when the article is appropriately placed between rows of bifacial solar photovoltaic modules or underneath the modules, solar energy that would otherwise strike the ground (or supporting surface, such as a rooftop) is instead, when said solar energy strikes the article from at least one angle within at least one defined range of angles relative to the solar reflecting article, reflected onto the side of at least one bifacial module that faces away from the sun. In this manner the article will increase the amount of electricity produced by at least one bifacial solar photovoltaic module.

### CROSS-REFERENCE TO RELATED APPLICATIONS

This application claims the benefit of the provisional patent application with U.S. application No. 62/614,384 filed Jan. 6, 2018 by the present inventor William Leonard Driscoll, titled “Rigid Sheet with Linear Array of Mirrored, Angled Grooves, to Improve Electricity Generation of Bifacial PV modules,” which is incorporated by reference in its entirety.

### DESCRIPTION

The present disclosure relates to reflective articles, and their use in coordination with bifacial photovoltaic (PV) modules.

Harnessing sunlight to generate electricity may be accomplished by the use of photovoltaic cells (also referred to as solar cells), which are used for photoelectric conversion (e.g., silicon photovoltaic cells). PV cells are relatively small in size and typically combined into a physically integrated PV module having a correspondingly greater power output.

Some PV modules are made with PV cells on both sides to increase the power output. While one side of the module is facing the sun, the other side can generate power using whatever solar energy may happen to reach it. An invention that could increase the amount of solar energy reaching the side of the PV module facing away from the sun, for example by redirecting solar energy toward that side of the PV module, would increase the PV module's power output.

Prior art in redirecting light includes the Fresnel lens (also called an “echelon lens”), which has been used in lighthouses to redirect light from a source such as a lantern into a focused beam of light that may be seen from ships at sea. The Fresnel lens incorporates grooves that use the effect of a prism to redirect light. The Fresnel lens refracts light, changing the direction of a light beam less than 90 degrees, and traditionally redirects light into a focused beam; newer variants of the Fresnel or echelon lens may refract light onto a linear target, for example to focus sunlight onto a pipe containing fluid to be heated. These characteristics of refracting and focusing light, either alone or in combination, make the Fresnel or echelon lens unsuitable for improving the electricity generation of the side of bifacial PV modules that faces away from the sun.

Prior art also includes redirecting solar energy using mirrors or specular surfaces. For example:
1. The use of mirrored parabolic surfaces that redirect light onto a tightly focused area (e.g., patented “Parabolic trough solar collector,” U.S. patent U.S. Pat. No. 4,423,719A). This technology is used in the technology of concentrating solar power, in which a field of parabolic mirrors redirects solar energy either to 1) fluid-containing pipes running parallel to the mirrors, at the focal point of the solar energy they redirect, or 2) a fluid-containing tank atop a tower, in which the fluid becomes heated. Either way, the heated fluid is used to generate electricity. The mirrors used redirect light onto a tightly focused area, making them unsuitable for redirecting light to the large surface area represented by a side of a bifacial PV module. The mirrors used are large, heavy to transport, require a supporting structure, and require sufficient strength to withstand wind; these characteristics make this technology less than ideal for redirecting light to increase the power output of bifacial PV modules.
2. Patented “Reflective device for a photovoltaic module with bifacial cells” (U.S. patent U.S. Pat. No. 9,012,765B2). This approach requires reconfiguring the manufacturing process for making bifacial PV modules, and also may increase the weight of such modules such that non-industry-standard PV module supports might be needed. These characteristics make this technology less than ideal for redirecting light to increase the power output of bifacial PV modules.
3. Use of V-shaped trough mirrors to reflect light onto the side of PV modules that faces the sun, as at the Carrisa Plains photovoltaic power plant. ^{1,2,3} The use of such mirrors does not redirect light to the side of bifacial PV modules facing away from the sun. ¹https://www.researchgate.net/figure/The-concentrator-V-trough-PV-module-52-220_fig3_254440012²https://ieeexplore.ieee.org/document/169280/³hhtp://www.fluor.com/projects/ar4co-power-solar-renewable-epc
4. As described in U.S. patent application 20180040757A1, use of a plastic film, manufactured in rolls up to six inches wide, comprising microscopic prisms aligned on a bias angle that are coated with a reflective coating, to redirect light, which enters a PV module but would strike a surface other than a photovoltaic cell, upwards at such an angle that it will be reflected by the module's “frontside” glass, which will then redirect it back toward the array of photovoltaic cells. The use of reflective plastic film within a PV module does not reflect light to the side of bifacial PV modules that faces away from the sun. The design of reflective plastic film with reflectors at angles to bounce light off of a module's “frontside” glass would have limited if any usefulness in redirecting light from the ground or a supporting surface to a bifacial PV module. A six-inch maximum width of reflective plastic film would have limited usefulness in redirecting light to PV modules of much larger dimensions. Reflective film, if placed between rows of bifacial PV modules, would be blown around by wind, such that: (1) in its new position it would at least in part reflect light in a diffuse and unmanaged manner, limiting its usefulness; (2) it could be damaged by wind; and (3) it could possibly land on PV modules and shade them from direct sunlight.
5. Suggested use of devices described as “semimirrors,” such as aluminum sheets, to redirect solar energy onto the side of bifacial PV modules that faces away from the sun.⁴ These semimirrors would require a supporting structure, as well as sufficient strength to withstand wind. These characteristics make this technology less than ideal for redirecting light to increase the power output of bifacial PV modules. ⁴Ooshaksarei, Poorya; Sopian, Kamaruzzaman; Zulkifli, Rozli; Alghoul, Mohammad; and H. Zaidi, Saleem. (2013). Characterization of a Bifacial Photovoltaic Panel Integrated with External Diffuse and Semimirror Type Reflectors. International Journal of Photoenergy. 2013. 10.1155/2013/465837.

Prior art also includes redirecting solar energy to the side of bifacial PV modules that faces away from the sun by improving the reflectivity of the ground or surface on which the modules are mounted. For example:
1. Applying a surface covering of lighter colored natural material such as sand or gravel. Such natural materials absorb some solar energy and reflect some solar energy, and they reflect solar energy in a manner that is diffuse and unmanaged—reflecting much solar energy uselessly in directions other than at the side of the PV modules that faces away from the sun.
2. Installing the bifacial PV modules above a somewhat reflective man-made surface such as concrete. As with a natural material such as sand, concrete absorbs some solar energy and reflects some solar energy, and it reflects solar energy in a manner that is diffuse and unmanaged—reflecting much solar energy uselessly in directions other than at the side of the PV modules that faces away from the sun.
3. Applying a light-colored surface coating to a man-made surface (e.g., a rooftop) on which the bifacial PV modules are installed. Light-colored surface coatings reflect some solar energy, but in a manner that is diffuse and unmanaged—reflecting much solar energy uselessly in directions other than at the side of the PV modules that faces away from the sun.

In light of the above, a need exists for a method and apparatus for using a solar energy reflecting article in combination with bifacial PV modules to reflect increased levels of solar energy to the side of the bifacial PV modules that faces away from the sun.

### SUMMARY

Bifacial PV modules have two sides that generate power, as solar energy that does not strike the “frontside” of a module (defined here as the side facing the sun) hits the ground (or supporting surface), and some of that solar energy is then reflected in an unmanaged scatter pattern; of this reflected solar energy, a less than optimal portion will reach the “backside” of a module (defined here as the side facing away from the sun).

The current invention is a thin, rectangular article encompassing at least one ordered arrangement of a plurality of reflector elements, each of which reflector elements has a primary reflective face at a primary angle of reflection. The article is intended to be placed between and/or underneath rows of bifacial solar photovoltaic modules, at a particular installation of such modules, to redirect solar energy—which would otherwise hit the ground (or supporting surface, such as a rooftop)—onto the side of the bifacial modules that faces away from the sun (the “backside”).

When the invention is properly positioned on the ground (or supporting surface) between and/or underneath rows of bifacial PV modules, it will redirect some of the solar energy that passes between the rows of PV modules onto the backside of the PV modules. More specifically, when the invention, with reflector elements properly designed for the reflector to be placed on the ground or supporting surface at a specific location, relative to bifacial PV modules mounted at a specific height in a specific row orientation (e.g., with rows aligned north-south) in a specific PV module installation, is properly placed at such location, the invention will reflect solar energy onto the backside of the bifacial PV modules when sunlight strikes the article from at least one angle within at least one defined range of angles relative to the solar reflecting article. The invention will thus serve to increase the bifacial PV modules' production of electricity.

This is an improvement over standard practice with bifacial PV modules, in which solar energy that passes between the rows of modules is partly absorbed by the ground or surface, and partly redirected in a diffuse and unmanaged way by the ground, ground covering, or surface. By definition, the backside of a bifacial PV module generates electricity when solar energy reaches it. By increasing the amount of (reflected) solar energy that reaches the backside of bifacial PV modules, the invention will serve to increase the amount of electricity the bifacial PV modules produce.

This is also an improvement over prior art in redirecting solar energy using mirrors, because the current invention does not require supporting structures, nor does it require sufficient strength to withstand wind, as it is designed to be placed flat on the ground (or supporting surface). If the invention is to be placed on the ground, the ground may be leveled in advance. Whether the invention is placed on the ground or on a supporting surface, it may be secured in place by any appropriate means.

### BRIEF DESCRIPTION OF THE DRAWINGS

FIG. 1 represents the utility of an embodiment of the invention (100) in late morning, when the sun is high in the east, and sunlight passing between the rows of modules strikes a section (112) of a variant (110) of the article (100) and is reflected to the backside of at least one bifacial PV module; another variant (120) of the article (100) is also shown.

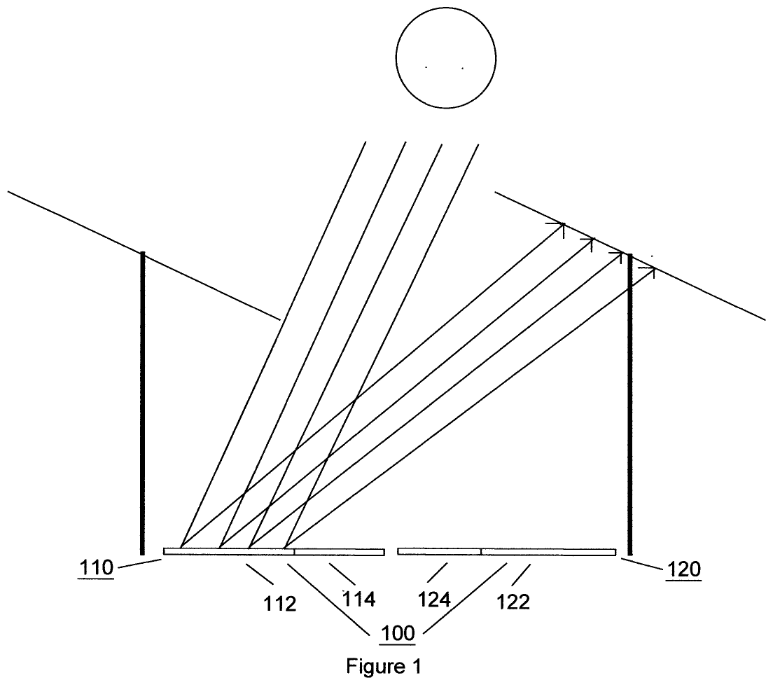

FIG. 2 represents the utility of an embodiment of the invention (100) around noon, when sunlight coming from above and passing between the rows of modules strikes a section (114) of a variant (110) of the article (100) and also strikes a section (124) of a variant (120) of the article (100) and is reflected to the backsides of two rows of bifacial PV modules.

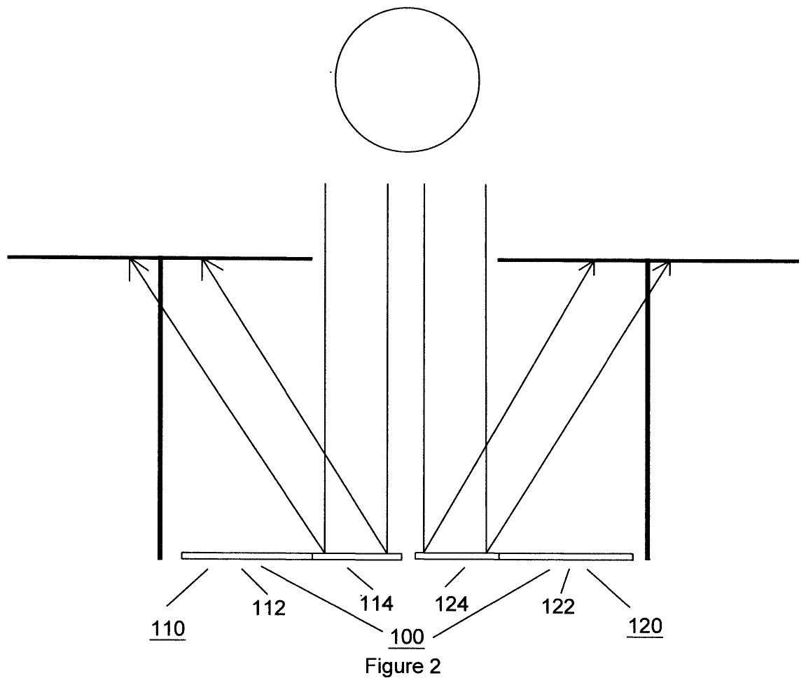

FIG. 3 represents the utility of an embodiment of the invention (100) in late afternoon, when the sun is high in the west and sunlight passing between the rows of modules strikes a section (122) of a variant (120) of the article (100) and is reflected to the backside of at least one bifacial PV module.

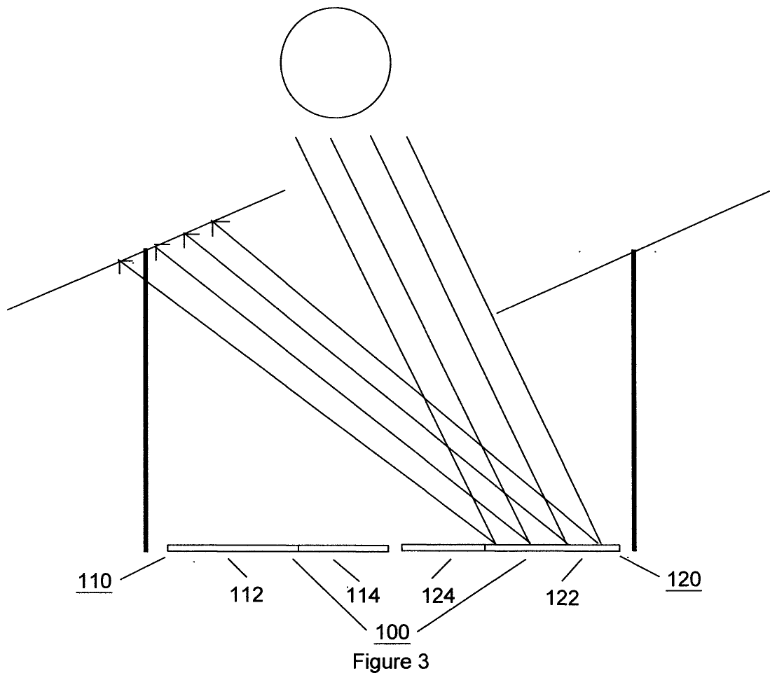

FIG. 4 represents a schematic cross section view of a portion of each of two variants (110, 120) of the invention (100), with the first variant (110) having two sections (112, 114) and the second variant (120) having two sections (122, 124). The cross-section view represents the following elements of the invention: the substrate (103); the plurality of reflector elements (104) in at least one ordered arrangement, which reflector elements each have a flat, angled face at an angle of primary reflection greater than 1 degree and less than 80 degrees relative to the plane of the article (100); the highly reflective layer or surface (105) on each angled face; the transparent or translucent protective top sheet (107); and the encapsulant (106) between (a) the substrate (103) with reflector elements (104) and highly reflective layer or surface (105), and (b) the top sheet (107)—with said top sheet being an element of a preferred embodiment.

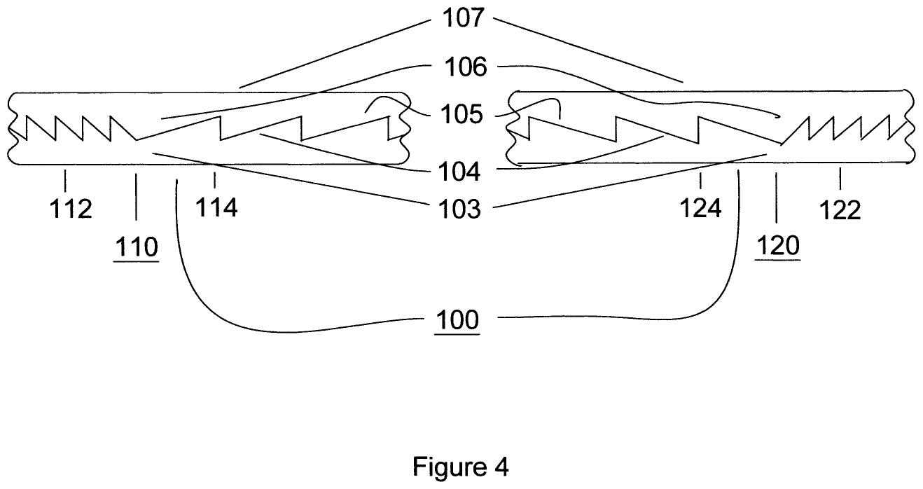

FIG. 5 represents a schematic cross section view of a portion of each of two variants (110, 120) of the invention (100). The cross-section view represents the following elements of a preferred embodiment of the invention: the sealant (108) and the frame (109). These elements surround the edges of each variant (110, 120) of the invention (100).

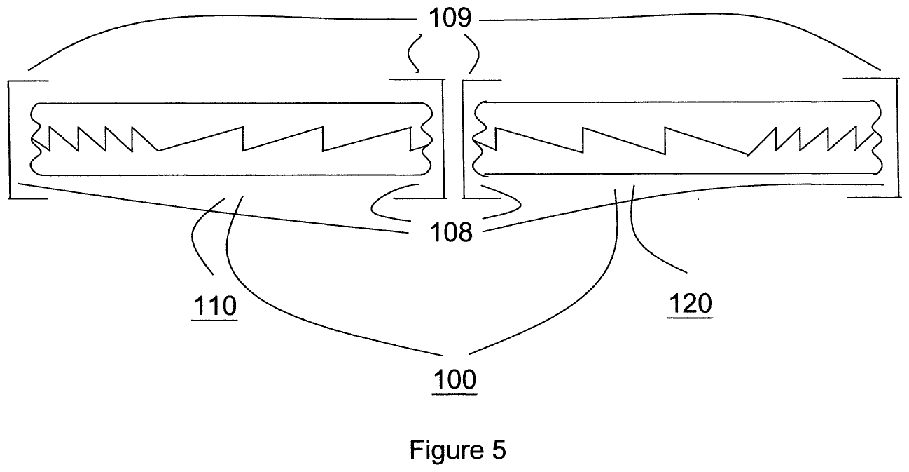

### DETAILED DESCRIPTION

As used herein, the term “ordered arrangement” when used to describe an arrangement of reflector elements, means an imparted pattern different from natural surface roughness or other natural features, where the arrangement can be continuous or discontinuous, can be a repeating pattern, a non-repeating pattern, a random pattern, etc.

As used herein, the term “highly reflective,” when used to describe the layer or surface (105) on each angled face of a reflector element, is defined as having an initial solar reflectance of at least 80 percent (or 0.80) when averaged across the wavelengths from 500 to 900 nm, or as measured by any accepted industry standard for measuring surface reflectance.

As used herein, the term “frontside,” when used to describe a side of a PV module, is defined as the side of a PV module that faces the sun at a given moment.

As used herein, the term “backside,” when used to describe a side of a PV module, is defined as the side of a PV module that faces away from the sun at a given moment.

As used herein, the term “angle of primary reflection,” when used in describing the angle of the primary reflective face of a reflector element (104), means the angle of that face of the reflector element that is between 1 degree and 80 degrees, relative to the plane of the article (100), and that is intended to reflect sunlight to the side of a bifacial PV module that faces away from the sun.

The invention described herein is manufactured using some of the same techniques for manufacturing PV modules. For example, in PV module manufacturing, PV cells are typically surrounded by an encapsulant, such as generally described in U.S. Patent Application Publication No. 2008/0078445 (Patel et al.), the teachings of which are incorporated herein by reference. In some constructions, known as bifacial PV modules, the PV module encompasses a transparent panel and encapsulant on both sides of the PV cells. Two panels of glass (or of a suitable polymeric material) are bonded to the opposing, front and back sides, respectively, of the PV cells, using encapsulant to bond the elements together. The two panels of glass or other material are relatively transparent to solar radiation and are typically referred to as the front-side layer and the backside layer (or backsheet). The front-side layer and the backside layer may be made of the same or a different material. The encapsulant is a light-transparent polymeric material that encapsulates the PV cells and also is bonded to the front-side layer and the backside layer so as to physically seal off the PV cells. This laminated construction provides mechanical support for the PV cells and also protects them against damage due to environmental factors such as wind, wind-blown dust or dirt, snow, and ice. The PV module is typically fit into a metal frame, with a sealant covering the edges of the module engaged by the metal frame. The metal frame protects the edges of the module, provides additional mechanical strength, and facilitates combining it with other modules so as to form a larger array that can be mounted to a suitable support that holds the modules together at a desired angle appropriate to maximize direct reception of solar radiation.

The art of making laminated modules is exemplified by the following patents, whose teachings are incorporated by reference: U.S. Pat. No. 4,751,191 (Gonsiorawski et al.); U.S. Pat. No. 5,074,920 (Gonsiorawski et al.); U.S. Pat. No. 5,118,362 (St. Angelo et al.); U.S. Pat. No. 5,178,685 (Borenstein et al.); U.S. Pat. No. 5,320,684 (Amick et al.); and U.S. Pat. No. 5,478,402 (Hanoka).

The invention is a solar energy reflecting article (100) incorporating a substrate (103) and encompassing at least one ordered arrangement of a plurality of substantially parallel reflector elements (104) projecting from the substrate (103). Each reflector element (104) has a certain height, length, and angle of primary reflection, whereby the height and angle of primary reflection define a primary reflective face.

The solar energy reflecting article (100) has at least one ordered arrangement therein, and preferably has a plurality of ordered arrangements therein. In one embodiment, the angle of primary reflection of each reflector element (104) is the same within a given ordered arrangement. The reflector elements (104) of each ordered arrangement reflect light to the backside of a PV module when light strikes the solar energy reflecting article from at least one angle within at least one defined range of angles relative to the solar reflecting article. In a preferred embodiment, the angle of primary reflection of the reflector elements (104) in any given ordered arrangement will differ from the angle of primary reflection of the reflector elements (104) in any other ordered arrangement.

Each reflector element (104) within an ordered arrangement extends along its length substantially continuously across its ordered arrangement, has a primary reflective face that is reasonably flat, and has a highly reflective layer or surface (105) on substantially all portions of that primary reflective face that may both (a) receive direct sunlight when the article is in position at a particular installation of photovoltaic modules and (b) reflect said sunlight to a side of a bifacial PV module, rather than to a neighboring reflector element.

In a preferred embodiment, the angle of primary reflection of the reflector elements (104) in the first ordered arrangement (112) of one variant (110) of the article (100) is different from the angle of primary reflection of the reflector elements (104) in the second ordered arrangement (114) of one variant (110) of the article (100), with each ordered arrangement reflecting light to the backside of a PV module when light strikes the solar energy reflecting article from at least one angle within at least one defined range of angles relative to the solar reflecting article.

Similarly, in a preferred embodiment, the angle of primary reflection of the reflector elements (104) in the first ordered arrangement (122) of one variant (120) of the article (100) is different from the angle of primary reflection of the reflector elements (104) in the second ordered arrangement (124) of one variant (120) of the article (100), with each ordered arrangement reflecting light to the backside of a PV module when light strikes the solar energy reflecting article from at least one angle within at least one defined range of angles relative to the solar reflecting article.

The reflector elements (104) each have an angle of primary reflection greater than 1 degree and less than 80 degrees relative to the plane of said article. Each primary reflective face has a highly reflective layer or surface (105). The highly reflective layer or surface (105) may be a layer that is separate and distinct from reflector elements (104), and having a certain thickness, or the highly reflective layer or surface (105) may be the surface of the primary reflective face of the reflector elements (104).

The angle of primary reflection of the reflector elements (104), relative to the plane of the article, can be measured clockwise from the plane of that article or counterclockwise from the plane of that article.

The reflector elements (104) within an ordered arrangement can be substantially identical with one another (e.g., within 5% of a truly identical relationship) in terms of at least shape and orientation, such that they are substantially parallel to one another (e.g., within 5% of a truly parallel relationship).

In a preferred embodiment, the substrate (103), with reflector elements (104) and highly reflective layer or surface (105), is laminated using an encapsulant (106) to a transparent or translucent protective top sheet (107). A top sheet (107) helps prevent the accumulation of dust and dirt on the highly reflective layer or surface (105), and facilitates cleaning of top side of the article (100).

The substrate (103) is made of polycarbonate in a preferred embodiment and is formed at the same time as its reflector elements (104) by injection molding. The drawings are schematic, in particular showing sharp internal and external corner edges for the reflector elements (104), and showing the backside of each reflector element at 90 degrees to the plane of the article; in fact, due in part to the requirements of injection molding, both the internal and external corner edges would be rounded and there would be sufficient draft (e.g., a minimum of two degrees) on the near-vertical side of each reflector element to permit the article, once formed, to be separated from the mold, and to facilitate continuous adhesion of reflective coating, for embodiments in which a reflective coating is used.

In a preferred embodiment, a highly reflective layer (105) is then applied to the surface of the reflector elements (104) by vapor deposition of aluminum. In other embodiments, a highly reflective layer (105) may be applied by vapor deposition of silver, a combination of silver and aluminum, or any suitable metal. Any desired highly reflective coating or mirror coating thickness can be used, for example on the order of 30-100 nm. Other embodiments may use a highly reflective layer of inorganic materials including oxides (e.g., SiO₂, TiO₂, Al₂O₃, Ta₂O₅, etc.) and fluorides (e.g., MgF₂, LaF₃, AlF₃, etc.). Other embodiments may use a layer comprising organic acrylics and other polymers, that can be modified with nanoparticles or used in combination with inorganic materials.

In a preferred embodiment, a protective top sheet (107) is added, which is made of tempered glass or another suitable rigid clear or translucent material, and which is laminated to the substrate, with its highly reflective layer or surface (105), using an ethylene vinyl acetate (EVA) encapsulant (106).

In a preferred embodiment, the edges of the article (100) are sealed with desiccant-filled polyisobutylene sealant (108) and enclosed with a frame (109) which is made of aluminum, in accordance with the teachings of several patents of the art of making laminated modules, incorporated by reference above. The sealant (108) extends substantially continuously between (a) the substrate and top sheet laminated together with encapsulant, and (b) the frame (109). The frame (109) has a height sufficient to encompass (a) the substrate and top sheet laminated together with encapsulant, and (b) the sealant. The frame (109) has a width sufficient to secure within the frame the substrate and top sheet laminated together with encapsulant.

The invention is intended to be placed between and/or underneath rows of bifacial PV modules, and optionally at the perimeter of an installation of bifacial PV modules, to increase the electricity production of the PV modules. The highly reflective layer or surface (105) redirects solar energy reaching the invention to the side of the bifacial PV modules facing away from the sun. Though not shown in the drawings, the invention may be placed at the perimeter of a solar photovoltaic installation, as well as between the rows.

The drawings represent the invention reflecting solar energy to bifacial PV modules aligned in north-south rows with single-axis tracking, such that the PV modules begin each day facing east in the morning and are gradually rotated to face west in the afternoon. The drawings represent the invention with reflector elements (104) with angles of primary reflection suitable for the solar installation proportions and other characteristics as represented in the drawings, as follows: PV module height, height of attachment of PV modules to the racking system, row spacing between rows of PV modules, PV module single-axis tracking, and placement of the invention relative to the PV modules. A person holding ordinary skill in the art could select different angles of primary reflection for the reflector elements (104), and different placement of the invention relative to the PV modules, that would be suitable for a bifacial PV module installation with different characteristics—for example, for use cases such as for bifacial PV module installations with different proportions between the module heights, attachment heights, and row spacing; for bifacial PV module installations with fixed vertical bifacial PV modules in north-south rows (without single-axis tracking); for bifacial PV module installations with south-facing modules (in the Northern Hemisphere); or for bifacial PV module installations with north-facing modules (in the Southern Hemisphere).

Although the present disclosure has been described with reference to preferred embodiments, workers skilled in the art will recognize that changes can be made in form and detail without departing from the spirit and scope of the present disclosure. For example:
The substrate (103) could be made from a polymeric material other than polycarbonate.
The substrate (103) encompassing reflector elements (104) could be manufactured by means of extrusion.
The substrate (103) encompassing reflector elements (104) could be manufactured by a process of 3-D printing.
The substrate (103) encompassing reflector elements (104) could be a thin flexible sheet. Such a sheet could be laminated to a rigid “sub-substrate.” Or such a sheet could be attached to a frame, as a painter's canvas is stretched across a frame, to help ensure a relatively flat surface, and thus help ensure a pattern of reflected solar energy that is relatively close to that intended by its design. Such a sheet, whether or not laminated to a substrate or attached to a frame, could also be anchored to the ground.
The substrate (103) encompassing reflector elements could be manufactured in more than one piece. For example, a set of molds could be used in injection molding with each mold producing a substrate (103) whose reflector elements (104) have a given angle of primary reflection. For a given bifacial PV module installation, substrate sheets—with reflector elements whose angles of primary reflection are at the appropriate angles—could be selected, cut to appropriate sizes, and combined into complete solar energy reflecting articles, by using a “sub-substrate” sheet of polycarbonate or other polymeric material the size of a complete solar energy reflecting article, and laminating the “sub-substrate” sheet to the appropriate selection of substrate sheets, already cut to size, using an encapsulant such as EVA.
The substrate (103) could be a sheet made of polymeric material that is white (or another light color) due to the incorporation of a pigmenting agent, such that the primary reflective faces of the reflector elements (104) would be reflective due to their white or light color, without any reflective coating.
The substrate (103) could be aluminum or other metal, with the reflector elements (104) formed by sheet metal embossing and the reflective layer or surface (105) being the surface of the primary reflective face of each reflector element (104).
The angle of primary reflection of the reflector elements (104) could differ within at least one ordered arrangement.
The highly reflective layer or surface (105) could be a coating of white paint or white elastomeric coating.
The encapsulant (106) can be any appropriate encapsulant, including encapsulants used in the PV module manufacturing industry.
The sealant (108) could be any appropriate sealant, including sealants used in the PV module manufacturing industry.
The frame (109) could be made of any rigid material.

In alternative embodiments, the invention may have a leveling mechanism, may have an anchoring mechanism, may have a supporting mechanism to raise it above the ground, and/or may have a rotational mechanism so that it may be conveniently rotated along one edge, for example to rotate it off the ground between rows of PV modules to facilitate access to the PV modules, and thus facilitate cleaning of the modules.

What is claimed is:

1. A solar energy reflecting article including:
a substrate layer defining a plane and encompassing:
at least one ordered arrangement of a plurality of substantially parallel reflector elements projecting from the substrate layer, with each reflector element having a certain height, length, and angle of primary reflection, whereby the height and angle of primary reflection define a primary reflective face;
wherein each of said reflector elements within an ordered arrangement extends along its length substantially continuously across its ordered arrangement, has a primary reflective face that is reasonably flat, and has a highly reflective layer or surface on substantially all portions of that primary reflective face that may both (a) receive direct sunlight when the article is in position at a particular installation of bifacial PV modules and (b) reflect said sunlight to a side of a bifacial PV module.

2. The solar energy reflecting article of claim 1, wherein the angle of primary reflection of each of said reflector elements has an angle relative to the plane of said substrate greater than 1 degree and less than 80 degrees.

3. The solar energy reflecting article of claim 1, wherein the angle of primary reflection of each of said reflector elements has an angle relative to the plane of said substrate greater than 5 degrees and less than 70 degrees.

4. The solar energy reflecting article of claim 1, wherein the angle of primary reflection of each of said reflector elements has an angle relative to the plane of said substrate greater than 10 degrees and less than 60 degrees.

5. The solar energy reflecting article of claim 1, wherein the substrate layer comprises a polymeric material.

6. The solar energy reflecting article of claim 1, wherein the reflector elements comprise a polymeric material.

7. The solar energy reflecting article of claim 1, wherein the reflective layer or surface is a layer comprising a material coating selected from the group consisting of a metallic material, an inorganic material, and an organic material.

8. The solar energy reflecting article of claim 1, further comprising an added clear or translucent top sheet made of a material selected from the group consisting of glass or polymeric material, with said top sheet being laminated to the substrate that encompasses reflector elements.

9. The solar energy reflecting article of claim 8, further comprising an added edge sealant on the edges and an added frame around the edges.

10. A means for or method of redirecting solar energy—which would otherwise strike the ground or supporting surface—onto a side of a bifacial PV module, thus increasing the electrical output of the bifacial PV module, whereby:
a substrate layer defines a plane and encompasses:
at least one ordered arrangement of a plurality of substantially parallel reflector elements projecting from the substrate layer, with each reflector element having a certain height, length, and angle of primary reflection, whereby the height and angle of primary reflection define a primary reflective face;
wherein each of said reflector elements within an ordered arrangement extends along its length substantially continuously across its ordered arrangement, has a primary reflective face that is reasonably flat, has an appropriate angle of primary reflection, and has a highly reflective layer or surface on substantially all portions of that primary reflective face, such that it may both (a) receive direct sunlight when the article is in position at a particular installation of bifacial PV modules and (b) reflect said sunlight to a side of a bifacial PV module;
the substrate encompassing reflector elements is placed in an appropriate location on the ground or supporting surface relative to the bifacial PV modules of a specific solar photovoltaic installation, such that solar energy passing between the rows of PV modules, from at least one angle within at least one defined range of angles relative to the solar reflecting article, strikes the solar energy reflecting article and is reflected onto the side of at least one bifacial PV module that faces away from the sun.
